(19) United States
(12) Patent Application Publication
(10) Pub. No.: US 2012/0208021 A1
(43) Pub. Date: Aug. 16, 2012

(54) CUTTING LINES FOR VEGETATION CUTTERS

(75) Inventor: TSUNG PEI YANG, CHANGHUA (TW)

(73) Assignee: YAO I FABRIC CO., LTD., CHANGHUA (TW)

(21) Appl. No.: 13/027,388

(22) Filed: Feb. 15, 2011

(51) Int. Cl. A01D 34/416; D02G 3/00

(52) U.S. Cl. 428/400

(57) ABSTRACT

A cutting line for vegetation cutters or trimmers includes a line which has a pre-set length and is a solid line with a cross section. At least one first recess unit is integrally and continuously formed in the outer surface and along the axis of the line. At least one second recess unit is integrally and continuously formed in the outer surface and along the axis of the line. The at least one first and second recess units are arranged in a pattern. The recesses of the at least one first and second recess unit do not wear to each other when the line is scrolled and reduce the chance to injure the user's hand. The line is light in weight.

### FIELD OF THE INVENTION

The present invention relates to a cutting line, and more particularly, to a cutting line of a vegetation cutter or trimmer.

### BACKGROUND OF THE INVENTION

The vegetation cutter or trimmer replaces the manual way using sickles by the use of electric-driving device to cut the plants which are cut when in contact with the cutter so that the plants are cut to be neat.

Generally, the above-mentioned electric-driving cutters or trimmers use two different cutting means which are blade and lines or filaments.

The conventional cutting line as disclosed in U.S. Pat. No. 5,687,482 includes four sharp edges which protrude out from the line so as to cut the plants. The cutting edges of the cutting line are spirally arranged along the axis of the line and have better cutting feature.

However, the spirally arranged cutting edges are easily worn out by mutual friction of the cutting edges when the cutting line is stored in the head of the cutting device. The cutting edges are worn and dull so that the cutting line cannot work properly and reduces the life of use and needs to be replaced frequently.

The present invention intends to provide an improved cutting line which includes multiple recesses defined in the outer surface of the line and the recesses are arranged in a pre-set pattern. The cutting line is light in weight and has better cutting efficiency.

### SUMMARY OF THE INVENTION

The present invention relates to a cutting line for vegetation cutters or trimmers includes a line which has a pre-set length and is a solid line with a cross section. At least one first recess unit is integrally and continuously formed in the outer surface and along the axis of the line. At least one second recess unit is integrally and continuously formed in the outer surface and along the axis of the line. The at least one first and second recess units are arranged in a pattern. The recesses of the at least one first and second recess unit do not wear to each other when the line is scrolled and reduce the chance to injure the user's hand. The line is light in weight.

The primary object of the present invention is to provide a cutting line which has multiple recesses arranged spirally in the outer surface of the line to increase the length of the cutting edges and the cutting efficiency.

The second object of the present invention is to provide a cutting line wherein the cutting edges are formed on the peripheries of the recesses so that the cutting line is light in weight.

The third object of the present invention is to provide a cutting line wherein the cutting edges are formed on the peripheries of the recesses so that when the cutting line is scrolled and stored, the cutting edges do not wear to each other.

The fourth object of the present invention is to provide a cutting line wherein the cutting edges are formed on the peripheries of the recesses so that when the user holds or pulls the cutting line, the user's hand is not cut by the cutting edges.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a cutter or trimmer equipped with the cutting line of the present invention;

FIG. 2 is a perspective view to show a section of the cutting line of the present invention;

FIG. 3 is a cross sectional view of the cutting line of the present invention;

FIG. 4 is a perspective view to show a section of the second embodiment of the cutting line of the present invention;

FIG. 5 is a perspective view to show a section of the third embodiment of the cutting line of the present invention;

FIG. 6 is a perspective view to show a section of the fourth embodiment of the cutting line of the present invention;

FIG. 7 is a cross sectional view of the cutting line in FIG. 6 of the present invention;

FIG. 8 is a perspective view to show a section of the fifth embodiment of the cutting line of the present invention;

FIG. 9 is a perspective view to show a section of the sixth embodiment of the cutting line of the present invention;

FIG. 10 is a perspective view to show a section of the seventh embodiment of the cutting line of the present invention;

FIG. 11 is a cross sectional view of the cutting line in FIG. 10 of the present invention;

FIG. 12 is a perspective view to show a section of the eighth embodiment of the cutting line of the present invention;

FIG. 13 is a perspective view to show a section of the ninth embodiment of the cutting line of the present invention;

FIG. 14 is a cross sectional view of the cutting line in FIG. 13 of the present invention;

FIG. 15 is a perspective view to show a section of the tenth embodiment of the cutting line of the present invention, and

FIG. 16 is a cross sectional view of the cutting line in FIG. 15 of the present invention.

### DETAILED DESCRIPTION OF THE PREFERRED EMBODIMENT

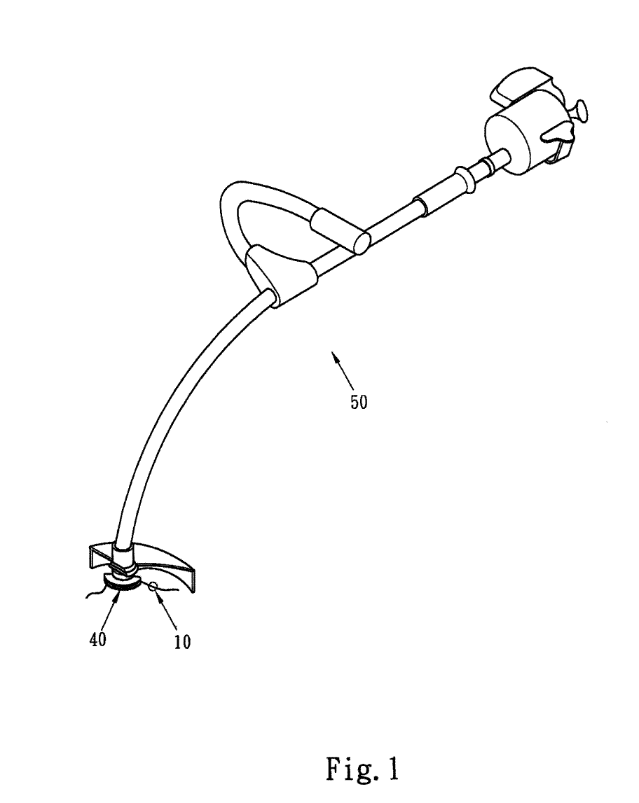

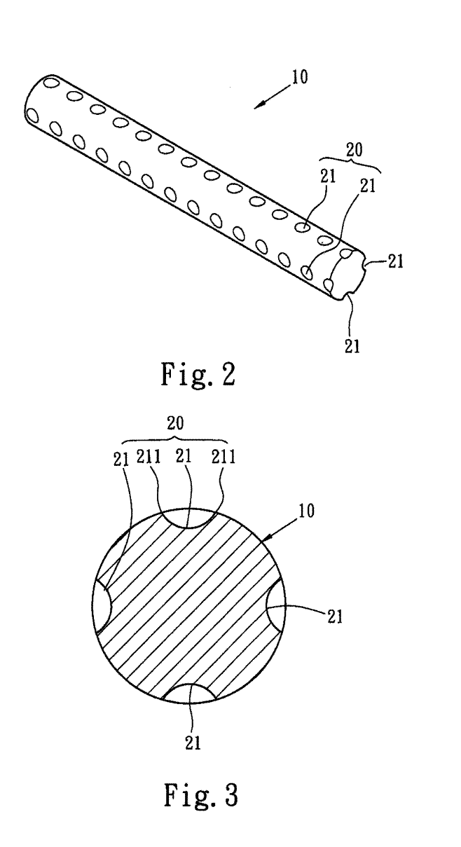

Referring to FIGS. 1 to 3, the cutting line 10 of the present invention is used with a cutting device 50 and can be scrolled and stored in a disk 40 of the cutting device 50. The exposed section of the cutting line 10 cuts plants. The cutting line 10 of the present invention is a solid line and has a pre-set length and a cross section. Four first recess units 20 are integrally and continuously formed in an outer surface of the line 10. The four first recess units 20 are continuously extended along the axis of the line 10. Each of the four first recess units 20 comprises multiple geometric shape recesses 21 and each recess 21 is a circular recess. The recesses 21 of the first recess units 20 are lined up along the axis of the line 10 and the four sets of the recesses 21 of the four first recess units 20 are arranged in a pre-set size, pre-set depth, pre-set number and pre-set spaced distance.

The recesses 21 of the first recess units 20 improve the drawbacks of the conventional cutting lines which easily cut the user's hand and the cutting edges are worn out when stored. The line 10 of the present invention is light in weight.

The line 10 of the present invention comprises multiple first recess units 20 which have recesses 21 linearly arranged to each other. The linearly arranged recesses 21 are continuously located in the outer surface of the line 10 and in parallel to the axis of the line 10. Each of the recesses 21 forms the cutting edge 211 at the intersectional portion between the recesses 21 and the outer surface of the line 10. Each recess 21 includes a circular cutting edge 211.

By using the cutting edges 211 located in the outer surface of the line 10 and the arrangement of the recesses 21 and the shape change of the cutting edges 211, the line 10 has improved cutting feature.

Compared with the conventional cutting line with protruding cutting edges, the line 10 of the present invention is lighter in weight. When the line 10 is connected to the disk 40, because the cutting edges 211 are in flush with the outer surface of the line 10, the cutting edges 211 do not contact each other so that the wearing problem can be improved and can have longer life of use. Furtheimore, the circular cutting edges 211 increase the cutting area which cuts the plants in every direction.

When the line 10 is not connected to the disk 40 and are scrolled and stored, the cutting edges 211 are formed on the first recess units 20 and do not protrude out from the outer surface of the line 10 so that when the lines 10 are scrolled and the stacked, the cutting edges 211 do not wear each other and the lines 10 have longer life.

When the conventional cutting line is connected to the disk, the user usually pulls the line out and the hand is easily cut by the protruded cutting edges which can injure the hand deeply. The cutting edges 211 of the line 10 of the present invention are not protruded out from the outer surface of the line 10 so that the change that the user's hand being cut is reduced.

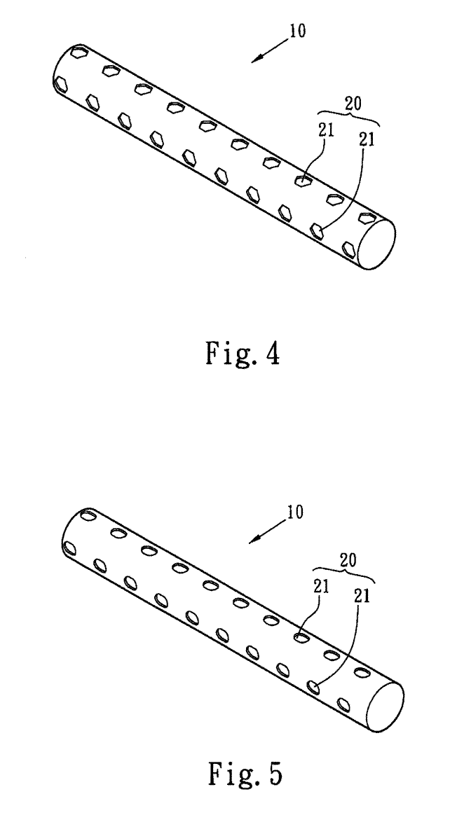

As shown in FIGS. 4 and 5 which show the second and third embodiments of the present invention, wherein the recesses 21 can be any geometric shape such as oval recess, hexagonal recess, triangular recess and rectangular recess. The cutting edges have the same function as the first embodiment.

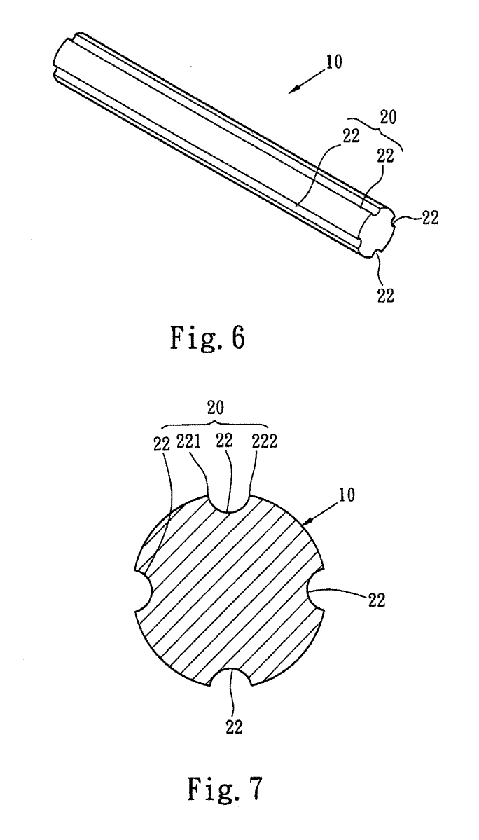

As shown in FIGS. 6 and 7 which show the fourth embodiment of the present invention, wherein each first recess unit 20 is a continuous groove 22 which has a depth. The four first recess units 20 form four grooves 22 with pre-set depth and located parallel to the axis of the line 10. The two sides of the groove 22 cut the outer surface of the line 10 to form two cutting edges 221, 222.

Compared with the previous embodiments the two cutting edges 221, 222 are located at two sides of the groove 22 so that the cutting efficiency is improved.

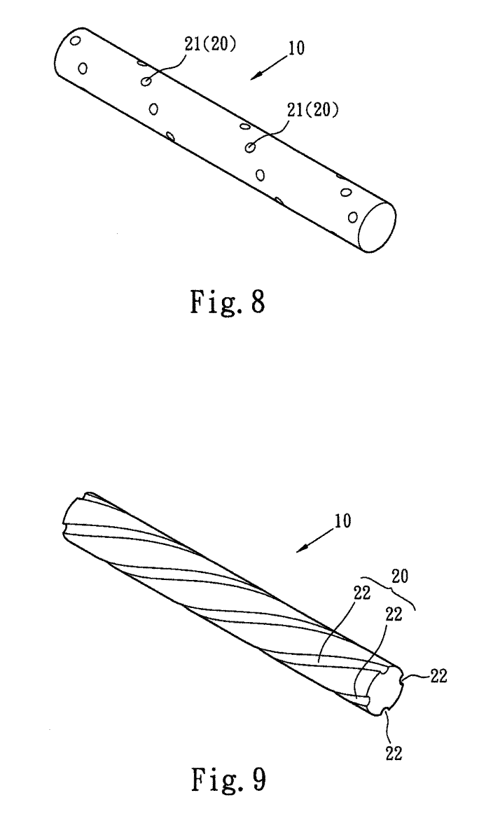

As shown in FIGS. 8 and 9 which show the fifth and sixth embodiments of the present invention, wherein the recesses 21 of the first recess units 20 are spirally formed along the axis of the line 10 and the recesses 21 can be any geometric shape and linearly lined. The four first recess units 20 spirally arranged along the line 10 and the four first recess units 20 can also be the grooves 22 mentioned above which are spirally formed in the line 10 and along the axis of the line 10.

The spirally arranged recesses 21 or grooves 22 of the present invention can achieve the pre-set function.

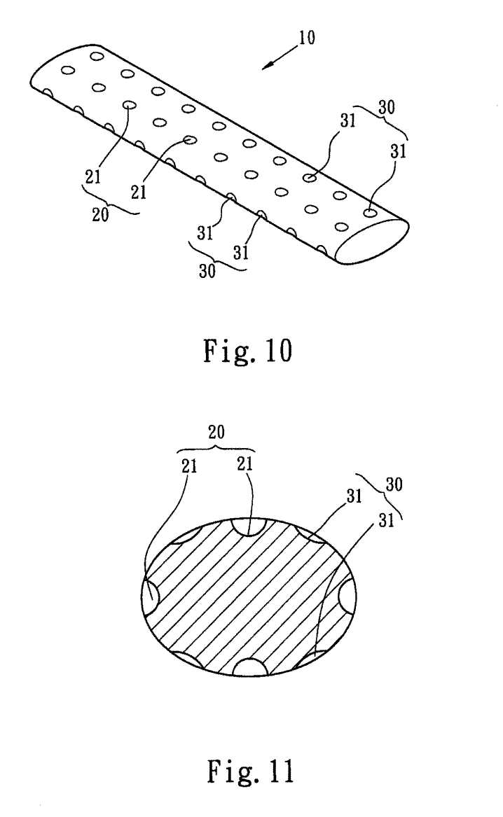

As shown in FIGS. 10 and 11 which show the seventh embodiment of the present invention, wherein the line 10 has an oval cross section and further comprises four second recess units 30 which are integrally and continuously formed in the outer surface of the line 10, and arranged along the axis of the line 10. The first and second recess units 20, 30 are arranged alternatively to each other. The first recess units 20 comprise multiple circular recesses 21 which are spaced by a distance and arranged as a line. The second recess units 30 comprise multiple circular recesses 31 which are spaced by a distance and arranged as a line. The depth of the recesses 21 of the first recess units 20 is deeper than the depth of the recesses 31 of the second recess units 30. The first and second recess units 20, 30 have geometric shape recesses 21, 31 which are alternatively arranged in the line 10 and the recesses 21 of the first recess units 20 and the recesses 31 of the second recess units 30 are located on common radiuses of the line 10.

The line 10 can be any known geometric shape and the first and second recess units 20, 30 and the depths of the first and second recess units 20, 30 can be arranged in a desired pattern to achieve the function.

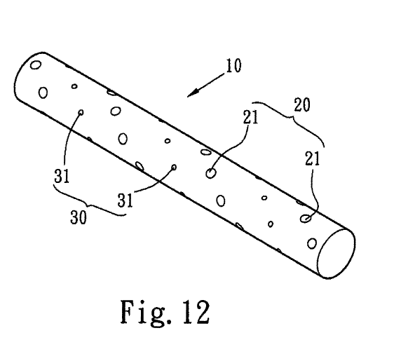

As shown in FIG. 12 which shows the eighth embodiment of the present invention, wherein the first and second recess units 20, 30 are arranged alternatively to each other. The first recess units 20 comprise multiple circular recesses 21 which are spaced by a distance and arranged as a line. The second recess units 30 comprise multiple circular recesses 31 which are spaced by a distance and arranged as a line. The diameter of the recesses 21 of the first recess units 20 is larger than the diameter of the recesses 31 of the second recess units 30. The first and second recess units 20, 30 have geometric shape recesses 21, 31 which are alternatively arranged in the line 10.

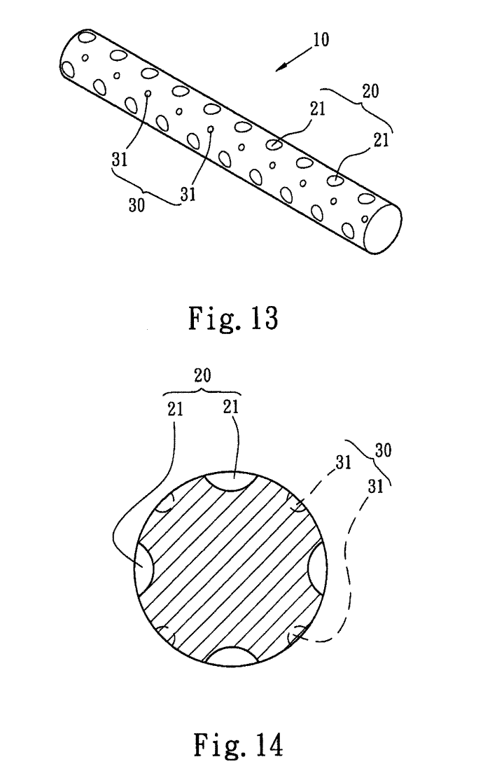

FIGS. 13 and 14 show the ninth embodiment of the present invention, wherein the recesses 21 of the first recess units 20 and the recesses 31 of the second recess units 30 are not located on common radiuses of the line 10, and the recesses 21 of the first recess units 20 and the recesses 31 of the second recess units 30 are located alternatively to each other.

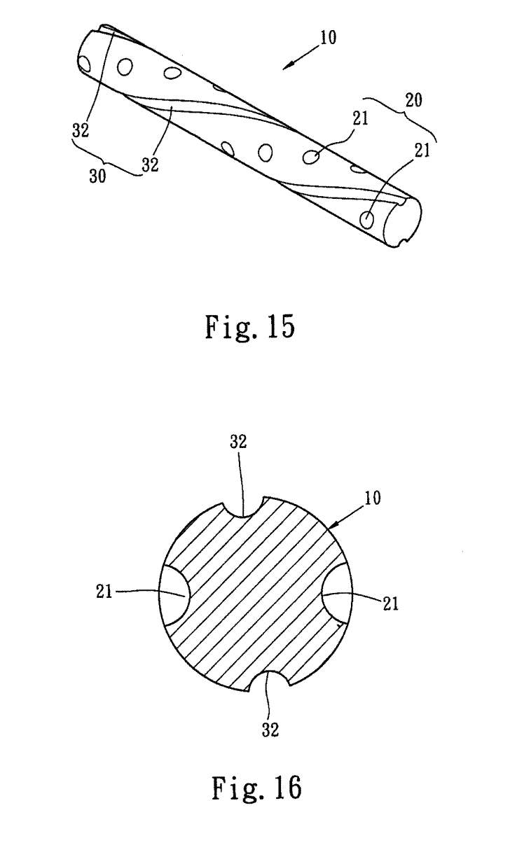

FIGS. 15 and 16 show the tenth embodiment of the present invention, wherein the first recess units 20 are composed of multiple recesses 21 and the second recess units 30 are grooves 32. The recesses 31 of the first recess units 20 and the grooves 32 of the second recess units 30 are located alternatively to each other. The grooves 32 have pre-set depth and are continuous grooves. The recesses 21 are circular recesses and spaced by a distance. The recesses 21 are spirally arranged in the outer surface of the line 10 and located along the axis of the line 10.

The embodiment has circular recesses 21 and grooves 32 in the outer surface of the line 10, and the cutting edges 211 of the recesses 21 and the cutting edges 311 of the grooves 32 can cut more plants in different directions.

While we have shown and described the embodiment in accordance with the present invention, it should be clear to those skilled in the art that further embodiments may be made without departing from the scope of the present invention.

What is claimed is:

1. A cutting line for vegetation cutters or trimmers, comprising:
a line being a solid line and having a length and a cross section;
at least one first recess unit integrally and continuously formed in an outer surface of the line.

2. The cutting line as claimed in claim 1, wherein the line comprises at least one second recess unit integrally and continuously formed in the outer surface of the line, the first and second recess units are arranged in a pattern.

3. The cutting line as claimed in claim 1, wherein the at least one first recess unit is a continuous groove which has a depth.

4. The cutting line as claimed in claim 1, wherein the at least one first recess unit comprises multiple recesses which have a geometric shape.

5. The cutting line as claimed in claim 2, wherein each of the at least one first and second recess units comprises multiple recesses which have a geometric shape.

6. The cutting line as claimed in claim 2, wherein the at least one first and second recess units are alternatively and spirally arranged in the outer surface of the line.

7. The cutting line as claimed in claim 2, wherein the at least one first and second recess units are alternatively and in parallel arranged in the outer surface of the line.

8. The cutting line as claimed in claim 2, wherein a diameter of the recesses of the at least one first recess unit is larger than a diameter of the recesses of the at least one second recess unit.

9. The cutting line as claimed in claim 2, wherein a depth of the recesses of the at least one first recess unit is deeper than a depth of the recesses of the at least one second recess unit.

10. The cutting line as claimed in claim 2, wherein the at least one first recess unit comprises a continuous groove with a depth, the at least one second recess unit comprises multiple geometric shape recesses, the at least one first and second recess units are alternatively arranged in the outer surface of the line.

11. The cutting line as claimed in claim 9, wherein the at least one first and second recess units are spirally and continuously arranged along an axis of the line.

12. The cutting line as claimed in claim 9, wherein the at least one first and second recess units are continuously and in parallel arranged along an axis of the line.

13. The cutting line as claimed in claim 2, wherein the at least one first and second recess units each have geometric shape recesses, the recesses of the at least one first recess unit and the recesses of the at least one second recess unit are located on a common radius of the line.

14. The cutting line as claimed in claim 2, wherein the at least one first and second recess units each have geometric shape recesses, the recesses of the at least one first recess unit and the recesses of the at least one second recess unit are located alternatively to each other and on different radiuses of the line.

15. The cutting line as claimed in claim 2, wherein the at least one first and second recess units each have geometric shape recesses, a number of the recesses of the at least one first recess unit and a number of the recesses of the at least one second recess unit are spaced from each other at a distance.
